(19) United States
(12) Patent Application Publication
(10) Pub. No.: US 2008/0012759 A1
(43) Pub. Date: Jan. 17, 2008

(54) Power control device for GPS receiver and method of controlling power thereof

(75) Inventor: Chang Te-Yi, Sijhih City (TW)

Correspondence Address: MCDERMOTT WILL & EMERY LLP, 18191 VON KARMAN AVE., SUITE 500, IRVINE, CA, 92612-7108, US

(73) Assignee: BEHAVIOR TECH COMPUTER CORP., Sijhih City (TW)

(21) Appl. No.: 11/822,920

(22) Filed: Jul. 11, 2007

(30) Foreign Application Priority Data
Jul. 12, 2006 (TW) 095125388

(51) Int. Cl. G01S 1/00

(52) U.S. Cl. 342/357.06

(57) ABSTRACT

A power control device for selectively outputting power to a GPS receiver includes a position sensor and a power control module. The power control module determines whether to output power to the GPS receiver according to the variation quantity of the position information after receiving the position information. Therefore, as long as the GPS receiver remains still, the GPS receiver can be turned off since there is no need to receive the position information.

### FIELD OF THE INVENTION

This invention relates to the power control devices, and more particularly, to the power control devices utilized in the GPS receivers.

### BACKGROUND OF THE INVENTION

The Global Positioning System (GPS) is currently the only fully functional Global Navigation Satellite System (GNSS). More than two dozen GPS satellites are in medium earth orbit, transmitting signals allowing the GPS receivers to determine the receiver's location, speed and direction.

Since the launch of first experimental satellite in 1978, GPS has become an indispensable tool to navigate around the world, and an important tool for map-production and land surveying. GPS also provides a precise time reference used in many applications including scientific study of earthquakes, and synchronization of telecommunications networks.

A GPS receiver calculates its position by measuring the distance between itself and three or more GPS satellites. Measuring the time delay between transmission and reception of each GPS radio signal obtains a distance from GPS receiver to each satellite. The signals also carry information of the satellites' location. By determining the positions of, and distances to, at least three satellites, the GPS receiver can compute its position using trilateration.

FIG. 1 is a block diagram showing a conventional satellite positioning receiver. As shown in FIG. 1, the conventional satellite positioning receiver 10 includes a Bluetooth module 12 and a GPS receiver 14. Both the Bluetooth module 12 and the GPS receiver 14 are directly powered by the power supply. Between the Bluetooth module 12 and the GPS receiver 14, the Universal Asynchronous Receiver Transmitter (UART) interface is used to transmit at least a position information.

When the GPS receiver 14 receives the position information provided by satellites, it generally transmits the position information to the Bluetooth module 12 at about every second. If the connection between the Bluetooth module 12 and a corresponding position information analyzer (not shown) is established, the received position information will be transmitted to the position information analyzer from the Bluetooth module 12. Otherwise, if the connection is not established, the received position information will be discarded.

Accordingly, when the connection between the Bluetooth module 12 and the position information analyzer is not established, there is no need for the Bluetooth module 12 to transmit the position information. Since there is no need to transmit the position information, the Bluetooth module 12, of course, does not need the information of the position information. Therefore, the GPS receiver 14 which provides the position information can be turned off for energy saving purpose. However, the Bluetooth module 12 can not be turned off, since it needs to stand by for the connection request.

As the design trend of electronic products is small-size and light-weight, the satellite positioning receiver needs to be smaller and lighter. The size of the battery, that occupies a lot of space and has a lot of weight, can not be reduced dramatically while increasing its capacity based on the current technology level. Therefore, an alternative way is to decrease the power consumption of the satellite positioning receiver, avoiding to utilize batteries of large size and capacity.

FIG. 2 is a block diagram showing another conventional satellite positioning receiver. As shown in FIG. 2, the conventional satellite positioning receiver 20 includes a Bluetooth module 22 and a GPS receiver 24. To lower the power consumption, only the Bluetooth module 22 is directly powered by the power supply, and the GPS receiver 24 is powered via a transmission line 16 through a power switch 18.

The power-saving design of the conventional satellite positioning receiver 20 determines whether to power the GPS receiver 24 based on the connection mode between the Bluetooth module 22 and the position information analyzer (not shown). In particular, if the connection is not established, the power switch 18 will turn off the power supplied to the GPS receiver 24. Otherwise, if the connection is established, the power switch 18 will turn on the power supplied to the GPS receiver 24. Therefore, the GPS receiver 24 is powered only when necessary, i.e., in a connection mode that may need to transmit the position information to the position information analyzer, so as to lower the unnecessary power consumption.

In addition to the factor of connection mode between the Bluetooth module 22 and the position information analyzer, the movement condition of a PDA or a vehicle which carries a GPS receiver 24 can also be used to determine whether to power the GPS receiver 24. In particular, if a PDA or a vehicle which carries a GPS receiver 24 does not move for a period of time, the position information received by the GPS receiver 24 does not vary. Since the position information does not vary, the GPS receiver 24 can be turned off to lower the power consumption.

### SUMMARY OF THE INVENTION

The objectives of the present invention are to provide a power control device and a power control method for a GPS receiver. When the position measured by the position sensor remains still, the GPS receiver remains still. Since the GPS receiver remains still, there is no need to receive the position information. The GPS receiver may be turned off under this scenario.

In accordance with one aspect of the invention, there is provided a power control device which includes a position sensor, e.g., gyroscope sensor or digital compass, for generating a position information; and a power control module coupled with the position sensor for selectively outputting the power to the GPS receiver according to a variation quantity of the position information.

In accordance with another aspect of the invention, there is provided a power control method for a GPS receiver, comprising the steps of: providing a position sensor and a power control module; generating a position information corresponding to the GPS receiver by the position sensor and transmitting the position information to the power control module; and selectively outputting the power to the GPS receiver according to a variation quantity of the position information during a predetermined period of time.

### BRIEF DESCRIPTION OF DRAWINGS

The foregoing and advantages of the invention will be appreciated more fully from the following further description thereof with reference to the accompanying drawings wherein:

FIG. 1 is a block diagram showing a conventional satellite positioning receiver.

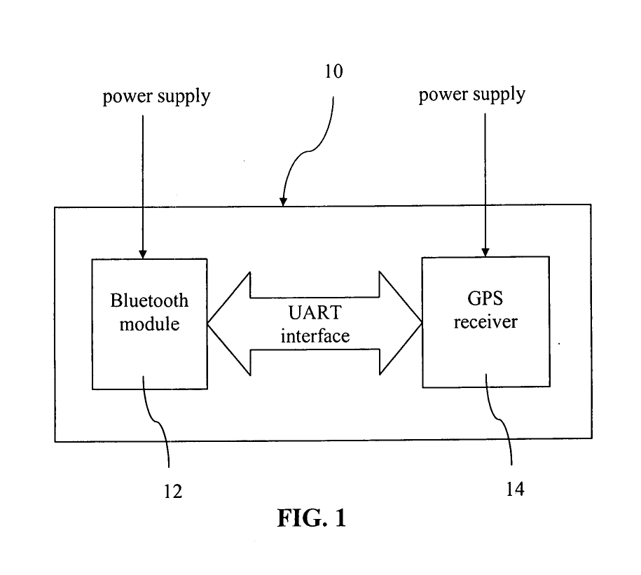

FIG. 2 is a block diagram showing another conventional satellite positioning receiver.

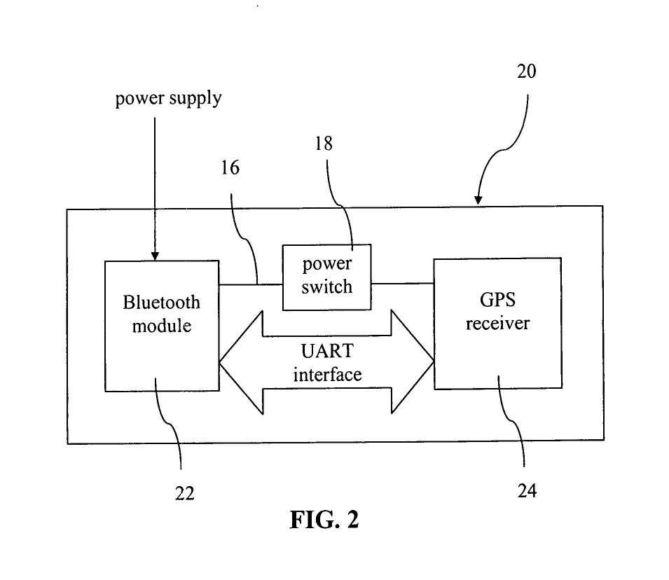

FIG. 3 is a schematic diagram showing the power control device of the GPS receiver according to an embodiment of the present invention.

FIG. 4 shows a flow chart of a power control method for a GPS receiver according to the present invention.

FIG. 5 shows a flow chart executed by the power control module according to the present invention.

FIG. 6 shows another flow chart executed by the power control module according to the present invention.

### DETAILED DESCRIPTION OF SPECIFIC EMBODIMENTS

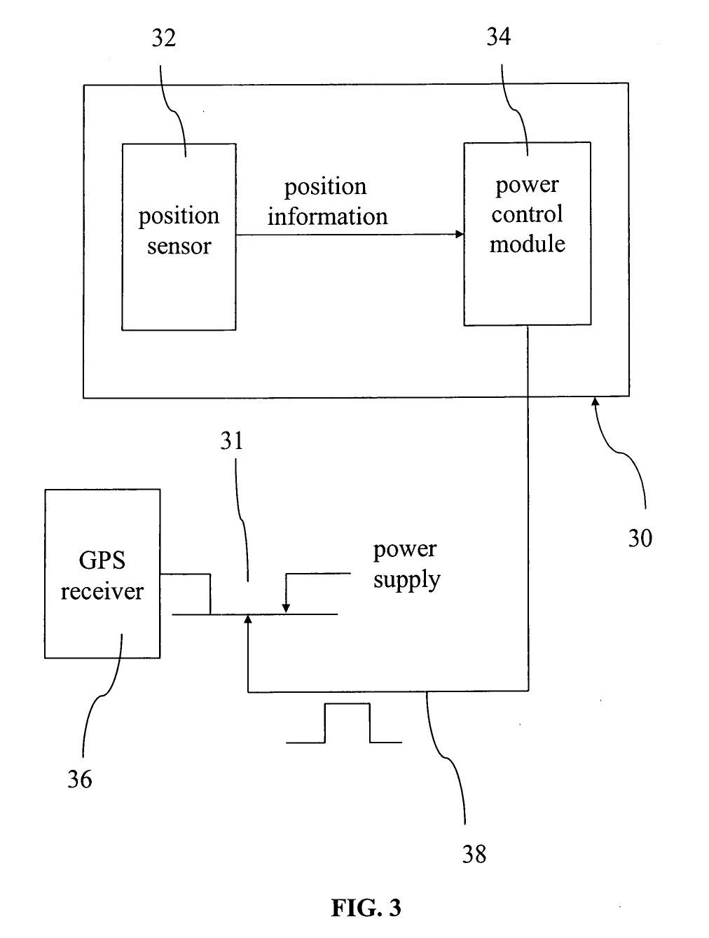

Referring to FIG. 3, FIG. 3 is a schematic diagram showing the power control device of the GPS receiver according to an embodiment of the present invention. As shown in FIG. 3, a power control device 30 for a GPS receiver according to the present invention includes a position sensor 32, e.g., gyroscope sensor or digital compass, and a power control module 34. The position sensor 32 is connected to the power control module 34 and is used to generate the position information. The power control module 34 selectively outputs the power to the GPS receiver 36 according to a variation quantity of the position information during a predetermined period.

In general, the power control device 30 and the GPS receiver 36 are both integrated in a mobile device (such as PDA) or vehicle. Therefore, the position information measured by the position sensor 32 of the power control device 30 is the same as that of the GPS receiver 36. Further, by determining whether the mobile device or the vehicle moves, the power control device 30 can infer whether the position information received by the GPS receiver 36 varies.

Accordingly, if the mobile device or vehicle does not move, it is inferred that the received position information does not vary. Since the position information does not vary, the power supplied to the GPS receiver 36 is temporarily turned off by the power control module 34, so as to lower the power consumption. Otherwise, as the mobile device or vehicle moves again, it is inferred that the position information varies. And the power control module 34 turns on the power supplied to the GPS receiver 36.

If it is determined by the power control module 34 that the position information does not vary for a predetermined amount of time, the power control module 34 will output an “OFF” power control signal 38 to the power switch 31. On the other hand, if it is determined that the position information varies, the power control module 34 will output an “ON” power control signal 38 to the power switch 31. The power switch 31 is connected among the power supply, GPS receiver 36, and power control module 34.

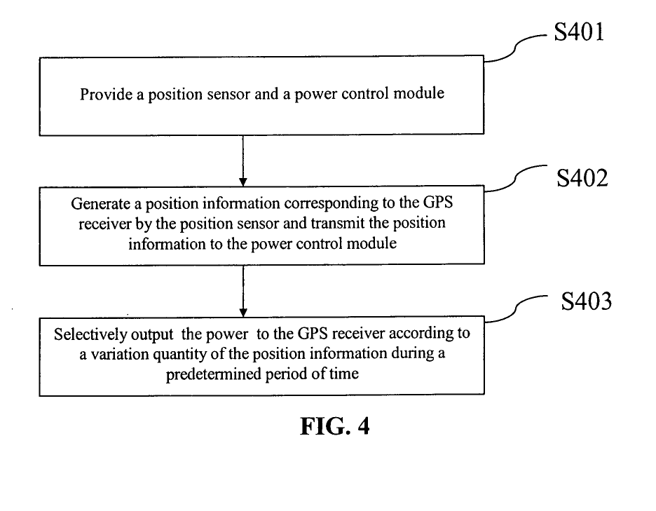

FIG. 4 shows a flow chart of a power control method for a GPS receiver according to the present invention. Firstly, a position sensor 32 and a power control module 34 are provided (S401). Secondly, the position sensor 32 generates the position information corresponding to the GPS receiver 36 and transmits the position information to the power control module 34 (S402). Thirdly, the power control module 34 selectively outputs the power to the GPS receiver 36 according to a variation quantity of the position information during a predetermined period of time (S403).

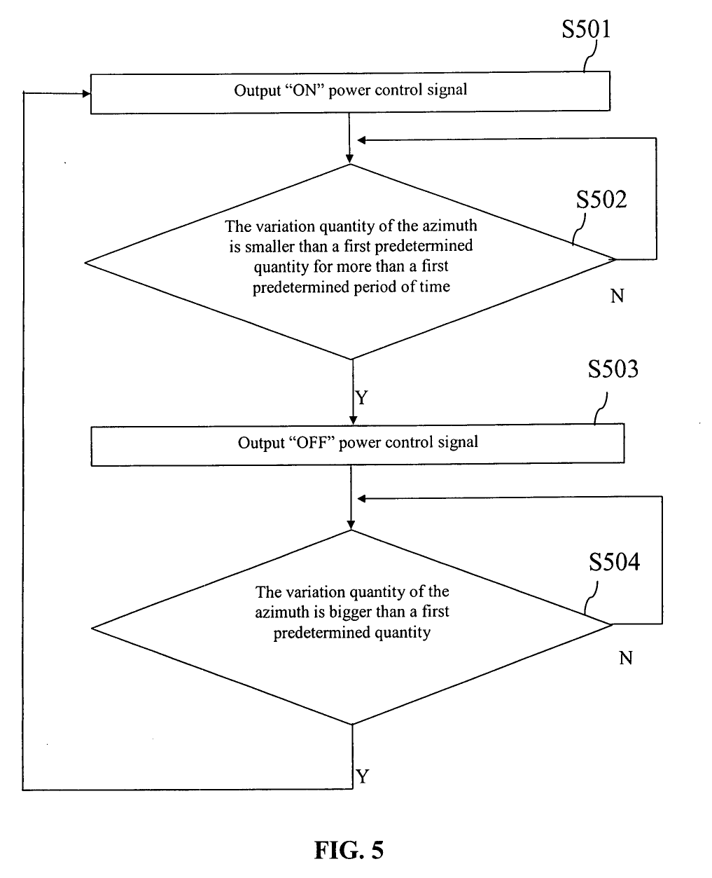

FIG. 5 shows a flow chart executed by the power control module 34 according to the present invention. The power control module 34 outputs an “ON” power control signal 38 to the power switch 31 (S501), such that the GPS receiver 36 is powered and starts to work. Then the process goes to step S502. In step S502, the power control module 34 determines whether the variation quantity of the azimuth is smaller than a first predetermined quantity for more than a first predetermined period of time. If the result is false, then the step S502 repeats. If the result is true, then the power control module 34 outputs an “OFF” power control signal 38 to the power switch 31 (S503), such that the GPS receiver is turned off and stops working. Then the process goes to step S504. In step S504, the power control module 34 determines whether the variation quantity of the azimuth is larger than a first predetermined quantity. If the result is false, then the step S504 repeats. If the result is true, then the process returns to step S501.

Specifically, since the position information provided by the position sensor 32 at least includes azimuth information, an “OFF” power control signal 38 is outputted to the power switch 31 when the variation quantity of the azimuth is smaller than a first predetermined quantity (such as 10 degrees) for more than a first predetermined period of time (such as 10 minutes). When the variation quantity of the azimuth is larger than a second predetermined quantity (such as 15 degrees), an “ON” power control signal 38 is outputted to the power switch 31 by the power control module 34.

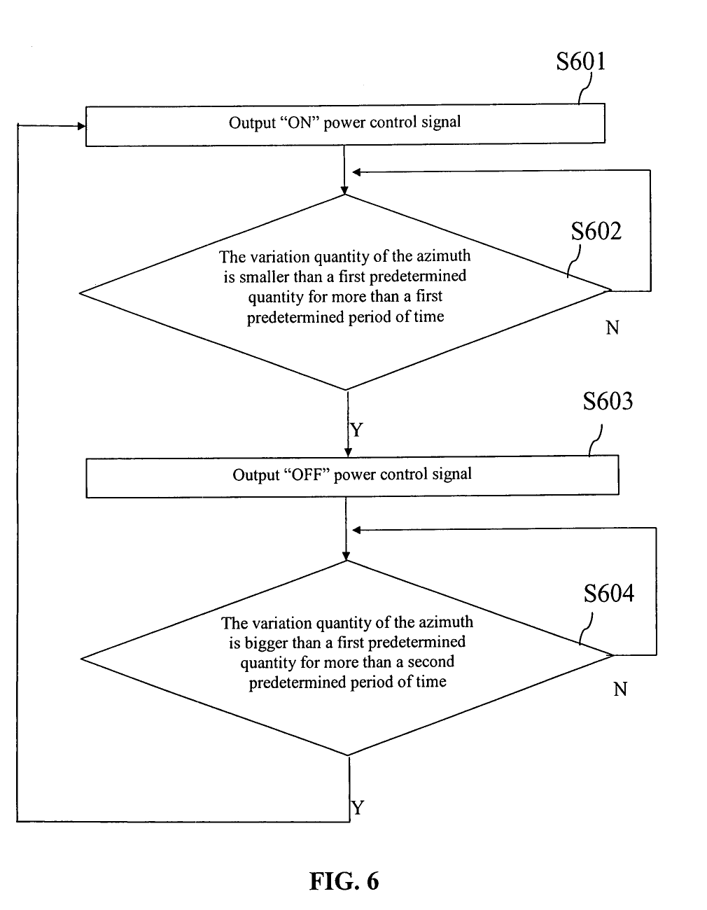

FIG. 6 shows another flow chart executed by the power control module 34 according to the present invention. The power control module 34 outputs an “ON” power control signal 38 to the power switch 31 (S601), such that the GPS receiver 36 is powered and starts to work. Then the process goes to step S602. In step S602, the power control module 34 determines whether the variation quantity of the azimuth is smaller than a first predetermined quantity for more than a first predetermined period of time. If the result is false, then the step S602 repeats. If the result is true, then the power control module 34 outputs an “OFF” power control signal 38 to the power switch 31 (S603), such that the GPS receiver is turned off and stops working. Then the process goes to step S604. In step S604, the power control module 34 determines whether the variation quantity of the azimuth is larger than a first predetermined quantity for more than a second predetermined period of time. If the result is false, then the step S604 repeats. If the result is true, then the process returns to step S601.

In an embodiment of the present invention, to prevent the power control device 30 (especially the position sensor 32) from being touched inadvertently causing a large variation quantity of azimuth, in addition to the condition of set forth for algorithm in FIG. 5, a second predetermined period of time (such as 15 minutes) is introduced in step S604. In other words, when the variation quantity of azimuth is larger than the second predetermined quantity for more than a second predetermined period of time, the GPS receiver 36 is powered and starts to work again.

The above mentioned power switch 31 includes MOSFETs, or other electronic switch elements.

The above mentioned power control module 34 includes a microcontroller. The microcontroller 34 receives the position information and outputs an “OFF” or “ON” power control signal 38 by determining the variation quantity of the position information in a predetermined period of time. The processes in FIGS. 5 and 6 can be implemented by a firmware which is executed by the microcontroller.

While various exemplary embodiments of the present invention are described herein, it should be noted that the present invention may be embodied in other specific forms, including various modifications and improvements, without departing from the sprit and scope of the present invention. Thus, the described embodiments are to be considered in all respects only as illustrative and not restrictive.

What is claimed is:

1. A power control device for selectively outputting power to a GPS receiver, comprising:
a position sensor for generating a position information; and
a power control module coupled with the position sensor for selectively outputting the power to the GPS receiver according to a variation quantity of the position information.

2. The power control device according to claim 1, wherein the position information comprises an azimuth.

3. The power control device according to claim 2, wherein the power control module outputs an “OFF” signal so as to turn off the GPS receiver as the variation quantity of the azimuth is smaller than a first predetermined quantity for more than a first predetermined period of time.

4. The power control device according to claim 2, wherein the power control module outputs an “ON” signal so as to turn on the GPS receiver as the variation quantity of the azimuth is larger than a second predetermined quantity.

5. The power control device according to claim 2, wherein the power control module outputs an “ON” signal so as to turn on the GPS receiver as the variation quantity of the azimuth is larger than a second predetermined quantity for more than a second predetermined period of time.

6. The power control device according to claim 1, wherein the power control module comprises a microcontroller for selectively outputting the power to the GPS receiver according to the variation quantity of the position information.

7. A power control method for a GPS receiver, comprising the steps of:
providing a position sensor and a power control module;
generating a position information corresponding to the GPS receiver by the position sensor and transmitting the position information to the power control module; and
selectively outputting the power to the GPS receiver according to a variation quantity of the position information during a predetermined period of time.

8. The power control method according to claim 7, wherein the position information comprises an azimuth.

9. The power control method according to claim 8, wherein the power control module outputs an “OFF” signal so as to turn off the GPS receiver as the variation quantity of the azimuth is smaller than a first predetermined quantity for more than a first predetermined period of time.

10. The power control method according to claim 8, wherein the power control module outputs an “ON” signal so as to turn on the GPS receiver as the variation quantity of the azimuth is larger than a second predetermined quantity.

11. The power control method according to claim 8, wherein the power control module outputs an “ON” signal so as to turn on the GPS receiver as the variation quantity of the azimuth is larger than a second predetermined quantity for more than a second predetermined period of time.

12. The power control method according to claim 7, wherein the power control module comprises a microcontroller to selectively output power to the GPS receiver according to the variation quantity of the position information.
